(19) United States
(12) Patent Application Publication
(10) Pub. No.: US 2018/0316218 A1
(43) Pub. Date: Nov. 1, 2018

(54) CORRECTING FOR ACCURACY DEGRADATION IN A CURRENT SENSING CIRCUIT OF A VOLTAGE REGULATOR

(71) Applicant: Lenovo Enterprise Solutions (Singapore) Pte. Ltd., Singapore (SG)

(72) Inventors: Brian C. Totten, Durham, NC (US); Luke D. Remis, Raleigh, NC (US); Douglas I. Evans, Cary, NC (US); Jamaica LaQuay Barnette, Durham, NC (US)

(21) Appl. No.: 15/581,234

(22) Filed: Apr. 28, 2017

(51) Int. Cl. H02J 13/00; G05B 15/02

(52) U.S. Cl. CPC H02J 13/0003; G05B 15/02

(57) ABSTRACT

A method includes sensing, using a current sensing circuit of a voltage regulator, an apparent amount of current output from the voltage regulator and identifying a present value of at least one operating parameter for the voltage regulator. The method further includes determining at least one current sense correction factor as a function of the identified present value of the at least one operating parameter, and calculating a corrected amount of current output from the voltage regulator as a function of the apparent amount of the current output and the at least one current sense correction factor. Still further, the method includes reporting the corrected amount of current to an integrated circuit that receives current output from the voltage regulator. The method may be performed in an apparatus, such as a server, that includes the voltage regulator, a baseboard management controller, and the integrated circuit.

### BACKGROUND

The present disclosure relates to voltage regulators and accurately reporting an amount of current output from a voltage regulator.

### BACKGROUND OF THE RELATED ART

A voltage regulator is an electronic circuit that is designed to control the output voltage at a constant level. Using a control loop, the voltage regulator senses the output voltage and automatically makes adjustments within the electronic circuit in order to maintain the output voltage constant at the selected voltage. For example, the voltage regulator may be used to stabilize the voltage of the direct current output that is supplied to a processor unit and other components of a computer.

Voltage regulators may include a current sensing circuit that is trimmed during manufacturing to ensure that the current sensing accuracy is within an expected tolerance range. However, the accuracy of the current sensing circuit can degrade over time. As the current sensing accuracy degrades, the performance of a server that receives current from the voltage regulator can also consequently suffer. A loss of accuracy in the current sensing circuit can ultimately result in excess unwanted power consumption or poorer performance per Watt of the processor unit and other components of a computer.

### BRIEF SUMMARY

One embodiment provides a method comprising sensing, using a current sensing circuit of a voltage regulator, an apparent amount of current output from a voltage regulator and identifying a present value of at least one operating parameter for the voltage regulator. The method further comprises determining at least one current sense correction factor as a function of the identified present value of the at least one operating parameter, and calculating a corrected amount of current output from the voltage regulator as a function of the apparent amount of the current output and the at least one current sense correction factor. Still further, the method comprises reporting the corrected amount of current to an integrated circuit that receives current output from the voltage regulator.

Another embodiment provides an apparatus comprising a voltage regulator having an electrical current output, a current sensing circuit and a current sense reporting circuit, wherein the current sensing circuit senses an apparent amount of current through the electrical current output, and wherein the current sense reporting circuit stores a current sense correction factor and calculates a corrected amount of current output from the voltage regulator as a function of the apparent amount of the current and the stored current sense correction factor. The apparatus further comprises a baseboard management controller in communication with the voltage regulator for identifying a present value of at least one operating parameter for the voltage regulator, determining a new current sense correction factor as a function of the identified present value of the at least one operating parameter, and replacing the current sense correction factor stored by the current sense reporting circuit with the new current sense correction factor. The apparatus still further comprises an integrated circuit in communication with the current sense reporting circuit for receiving the corrected amount of the current output and controlling an amount of workload performed by the integrated circuit as a function of the corrected amount of the current output.

### BRIEF DESCRIPTION OF THE SEVERAL VIEWS OF THE DRAWINGS

FIG. 1 is a diagram of a server including a voltage regulator and a baseboard management controller.

FIGS. 2A and 2B are illustrations of a lookup table that associates the present value of an operating parameter of the voltage regulator with current sense correction factors.

FIG. 3 is a flowchart of a method according to one embodiment.

FIGS. 4A-4C are flowcharts for processes performed by the voltage regulator, baseboard management controller, and integrated circuit according to another embodiment.

### DETAILED DESCRIPTION

One embodiment provides a method comprising sensing, using a current sensing circuit of a voltage regulator, an apparent amount of current output from a voltage regulator and identifying a present value of at least one operating parameter for the voltage regulator. The method further comprises determining at least one current sense correction factor as a function of the identified present value of the at least one operating parameter, and calculating a corrected amount of current output from the voltage regulator as a function of the apparent amount of the current output and the at least one current sense correction factor. Still further, the method comprises reporting the corrected amount of current to an integrated circuit that receives current output from the voltage regulator.

The at least one operating parameter may be any measurable or determinable parameter that is correlated to degradation in the accuracy of the current sensing circuit. For example, the at least one operating parameter may be cumulative power-on time, cumulative time in operation above a temperature threshold, cumulative time in operation above a current threshold, present age of the voltage regulator, and combinations thereof. Optionally, the at least one operating parameter may be a plurality of operating parameters.

A voltage regulator having a current sensing circuit may be characterized in a test condition, wherein the test equipment collects and stores the current sense output of the current sensing circuit, various other operating conditions of the voltage regulator that is being tested, and independent current measurements. The collected data may then be analyzed to determine what operating parameters degrade the current sense accuracy, where the current sense accuracy degradation may be determined as the difference between the independent current measurements and the current sense output of the current sensing circuit of the voltage regulator over time. By selecting highly accurate equipment to collect the independent current measures, the accuracy degradation (error) of the current sensing circuit results in a gradual drifting apart of the two measurements. In particular, the collected data may be analyzed to identify at least one operating parameter of the voltage regulator that correlates with the accuracy degradation (error) of the current sense circuit. In one non-limiting example, the collected data may be analyzed using regression analysis, such as a linear regression analysis between current sense accuracy degradation (as the independent variable) and various of the collected operating parameters or combinations of operating parameters (as the dependent variable). More specifically, if the current sense accuracy degradation is found to vary linearly with cumulative power-on time, then such linear correlation may be characterized in a lookup table or as a mathematical function. For example, a lookup table may include multiple records (i.e., rows), where each record (row) associates a value (or range of values) for the operating parameter with at least one correction factor, such as a gain value and an offset value. In a lookup table, one or more correction factor may be associated with one or more operating parameter by virtue of being in the same record (row) of the table. The at least one current sense correction factor in each record is predetermined to correct for an amount of current sensing accuracy drift measured in a voltage regulator. The lookup table may then be used in systems having a voltage regulator that is nominally similar to the voltage regulator that was characterized. The nominally similar voltage regulator may be expected to have a similar amount of current sense accuracy drift when observed to have similar values of the at least one operating parameter. Over time, the system may dynamically update the at least one current sense correction factor being used by the current sense reporting circuit in response to changes in the present value of the operating parameter. In one example, the current sense reporting circuit may output a reported current according to the equation: reported current=(apparent current+offset)×gain.

As used herein, “nominally similar” voltage regulators typically have the same rating or model number, such that two “nominally similar” voltage regulators are expected to perform the same and the current sensing circuits of the voltage regulators are expected to experience a similar amount and character of accuracy drift with similar use. The term “nominally similar” allows for a normal range of differences between voltage regulators that are made within the tolerances of a given manufacturing specification. “Nominally similar” voltage regulators may often have the same rating, the same model number or the same stock keeping unit (SKU).

In one embodiment, determining at least one current sense correction factor as a function of the identified present value of the at least one operating parameter, may include using a lookup table to find the at least one current sense correction factor that is associated with the identified present value of the at least one operating parameter. The lookup table may include multiple records based on actual current sense accuracy drift data collected during operation of another voltage regulator that is nominally similar to the voltage regulator, wherein each record includes a value for the at least one operating parameter and a value for the at least one current sense correction factor. In one option, the at least one current sense correction factor may include an offset value and a gain value. In another option, the at least one operating parameter may include accumulated power-on time.

In a further embodiment, the integrated circuit is in communication with the current sense reporting circuit for receiving the corrected amount of the current output and controlling an amount of workload performed by the integrated circuit as a function of the corrected amount of the current output. Optionally, the integrated circuit may be a central processing unit.

Another embodiment provides an apparatus comprising a voltage regulator having an electrical current output, a current sensing circuit and a current sense reporting circuit, wherein the current sensing circuit senses an apparent amount of current through the electrical current output, and wherein the current sense reporting circuit stores a current sense correction factor and calculates a corrected amount of current output from the voltage regulator as a function of the apparent amount of the current and the stored current sense correction factor. The apparatus further comprises a baseboard management controller in communication with the voltage regulator for identifying a present value of at least one operating parameter for the voltage regulator, determining a new current sense correction factor as a function of the identified present value of the at least one operating parameter, and replacing the current sense correction factor stored by the current sense reporting circuit with the new current sense correction factor. The apparatus still further comprises an integrated circuit in communication with the current sense reporting circuit for receiving the corrected amount of the current output and controlling an amount of workload performed by the integrated circuit as a function of the corrected amount of the current output.

In one option, the integrated circuit may be a central processing unit, wherein the central processing unit and the baseboard management controller are installed on the motherboard of a server. In another option, the baseboard management controller may determine the new current sense correction factor using a lookup table to find a current sense correction factor that is associated with the identified present value of the at least one operating parameter. In a further option, the apparatus may incorporate any one or more detail described above in regard to the method embodiments.

Embodiments of the apparatus may further include a data storage device for storing program instructions that may be executed by the baseboard management controller for implementing or initiating any one or more aspects of the methods described herein.

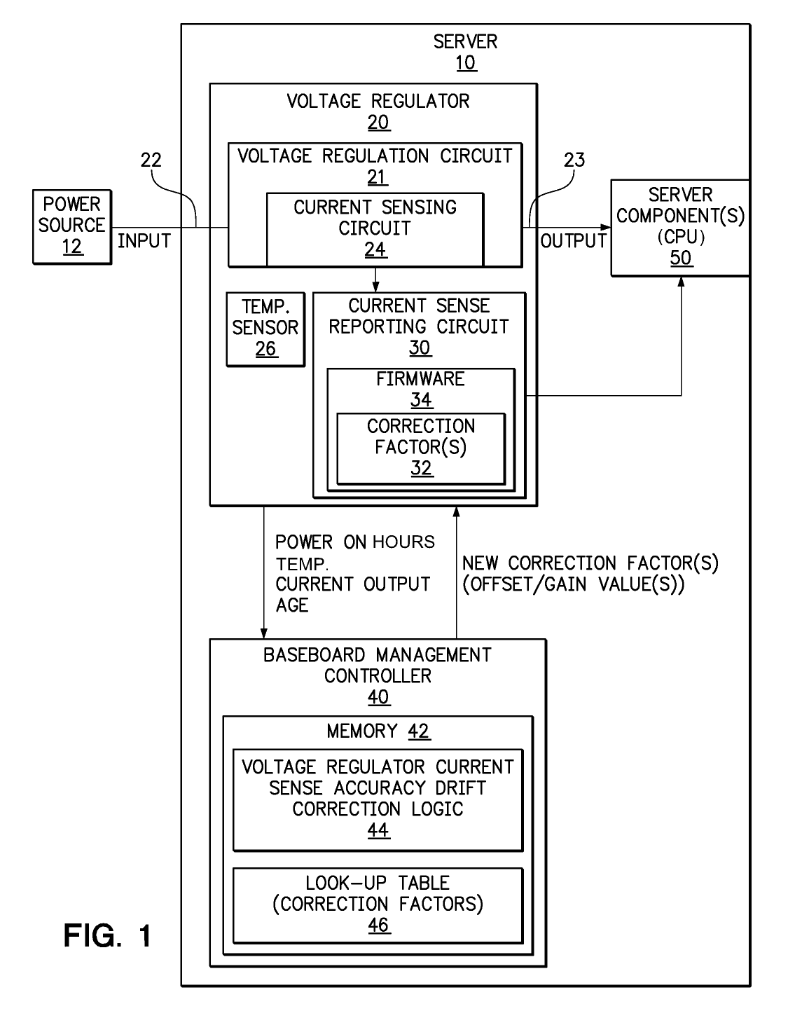

FIG. 1 is a diagram of a server 10 including a voltage regulator 20, a baseboard management controller 40, and other server components 50. The voltage regulator 20 includes a voltage regulation circuit 21 having an electrical current input 22 (either AC or DC) from a power source 12 and an electrical current output 23 (DC) to the server components 50. The voltage regulator 20 further includes a current sensing circuit 24 and a current sense reporting circuit 30, wherein the current sensing circuit 24 senses an apparent amount of current through the electrical current output 23, and wherein the current sense reporting circuit 30 stores a current sense correction factor 32 in firmware 34. For example, the firmware 34 may be implemented in an electronically programmable read-only memory (EPROM) device or flash memory. Accordingly, the current sense reporting circuit 30 may calculate a corrected amount of current output from the voltage regulator as a function of the apparent amount of the current, which is received from the current sensing circuit 24, and the stored current sense correction factor 32.

The baseboard management controller 40 is in communication with the voltage regulator 20 for identifying a present value of at least one operating parameter for the voltage regulator, determining a new current sense correction factor as a function of the identified present value of the at least one operating parameter, and replacing the current sense correction factor stored by the current sense reporting circuit with the new current sense correction factor. The baseboard management controller 40 may, for example, detect that the voltage regulator is turned on in order to determine a cumulative power-on time (i.e., hours) for the voltage regulator, or detect the temperature measured by a temperature sensor 26 in order to determine an amount of time that the voltage regulator is in operation above a temperature threshold.

The other server components 50 may include an integrated circuit in communication with the current sense reporting circuit 30 for receiving the corrected amount of the current output and controlling an amount of workload performed by the integrated circuit as a function of the corrected amount of the current output.

The baseboard management controller 40 may dynamically update the voltage regulator firmware 34 to improve voltage regulator accuracy and system performance over the life of the server 20. Specifically, the voltage regulator includes a current sense reporting module or circuit 30 that corrects the apparent current amount, which is received from the current sensing circuit 24, using at least one correction factor 32, such as an offset value and a gain value. The offset value and/or the gain value are dynamically updated by the baseboard management controller 40 with a value that is selected as a function of, or in response to, a present value of at least one operating parameter of the voltage regulator. Non-limiting examples of an operating parameter include cumulative power-on time, cumulative time in operation above a temperature threshold, cumulative time in operation above a current threshold, present age of the voltage regulator, and combinations thereof. Accordingly, updating the offset value and/or the gain value over time with changes in operating parameter improves the accuracy of the reported current value that the current sense reporting circuit 30 provides to the server components (load) 50. The corrected current value may be reported to one or more of the server components 50, such as a CPU, other integrated circuit or other server component, so that the load can control its behavior as a function of that reported current value. For example, if the CPU 50 receives the reported current value and determines that the voltage regulator 20 is delivering less than a threshold amount of current, then the CPU 50 may decide to perform more work or a different workload. Conversely, if the CPU is receiving a current reporting value that indicates the voltage regulator is delivering a relatively high amount of current based on historical or preset maximum current values, then the CPU may decide to perform less work or a different workload. The CPU or other server component 50 can make better workload decisions if the CPU receives current reporting values that are more accurate. Accordingly, improving the current sense accuracy that is reported by the voltage regulator may result in performance gains for the server 20.

The baseboard management controller (BMC) 40 monitors at least one operating parameter for a voltage regulator 20 and has access to memory 42 that stores current sense accuracy drift correction logic 44 and current sense correction factors 46. The current sense correction factors 46 are associated with one or more operating parameters. These associations are preferably predetermined based on actual current sensing accuracy drift data for the voltage regulator 20, perhaps during server development. For example, current sense correction factors 46 (such as an offset value and a gain value) may be associated with different values of one or more operating parameters, wherein the correction factors 46 are determined to correct for the current sensing accuracy drift that is found to occur in a nominally similar voltage regulator having a similar amount of wear (i.e., similar values of the one or more operating parameters). Essentially, the current sense correction factors 46 associated with a present value of the operating parameters (i.e., parameters that degrade the accuracy of the current sensing circuit) may be provided to the firmware 34, such that the correction factors 32 (such as offset and gain values) may be applied to a sensed current value in order to correct for an amount of current sense accuracy drift that is expected based on the present values of the operating parameters. Accordingly, the current sense correction factors 46 associated with the present values of one or more operating parameters may be pushed from the BMC 40 to the voltage regulator 20, wherein the correction factors received by the voltage regulator 20 are stored in the firmware 34 as correction factors 32 and used for the purpose of improving the accuracy of the reported value of the output current of the voltage regulator. As a specific example, the BMC may push the selected current reporting offset value and/or gain value to the voltage regulator to improve the current reporting accuracy. A new offset value, new gain value or both may be selected and pushed to the voltage regulator at various times, such as continuously, periodically, or in response to various conditions or events. Maintaining voltage regulator current reporting accuracy in this manner may improve system performance over life. For example, the system may experience an improvement in power efficiency or total workload performance.

The current sensing circuit 24 of the voltage regulator 20 may or may not sense the output current in a single location of the voltage regulator. For example, a voltage regulator may have multiple phases, where the output current of each phase may be sensed and reported separately, then added together to obtain a total current sense output. Alternatively, the voltage regulator circuit 21 may provide a single signal that indicates the cumulative output current. The separate output current values or the cumulative output current value may be used in one or more control loop to maintain the voltage regulator's output current(s) at a selected level. Furthermore, a power supply or a server may include one or more voltage regulators. In one example, a power supply may include multiple voltage regulators, where each voltage regulator provides output current at a different voltage level, such as +3.3V, +5V, +12V and −12V.

Embodiments may be further understood by reference to various non-limiting examples that use one or more operating parameters that are found to be “accuracy degrading parameters” (i.e., cumulative power on time, cumulative time in operation above a temperature threshold, cumulative time in operation above a current threshold, present age of the voltage regulator, etc.). There operating parameters are obtained by the BMC in order to calculate or select an updated “offset value” and “gain value” that will counteract the current accuracy drift error. Such accuracy degrading parameters may be measured directly by sensors that report to the BMC or may be obtained by communication with the voltage regulator.

In one specific example, the BMC monitors power-on hours, operating temperature and output current of a voltage regulator. If the BMC determines that the voltage regulator has accumulated power-on hours exceeding a predetermined number of N hours of operation during which the voltage regulator had an operating temperature >30° C. and/or an output current >50 A, or if the BMC determines that the voltage regulator has an age >1 year, then the BMC changes a gain value from X→Y and/or changes an offset value from A→B. The BMC would then send the new gain value of Y and the new offset value of B to the firmware of the voltage regulator for use in current sense reporting.

It should be understood that methodologies or logic for using the accuracy degrading operating parameters to identify and update offset and gain values to be used by the voltage regulator could be more or less complex in practice. In a simple form, the methodology could increment the gain by a value “−X” for each year of the voltage regulator's age. In a more complex form, the methodology could determine a total amount of power delivered by the voltage regulator to date since manufacturing and then periodically provide a new gain value and/or an offset value based on the total amount of power delivered. The offset value and the gain value may each be either calculated using an equation or selected from a lookup table.

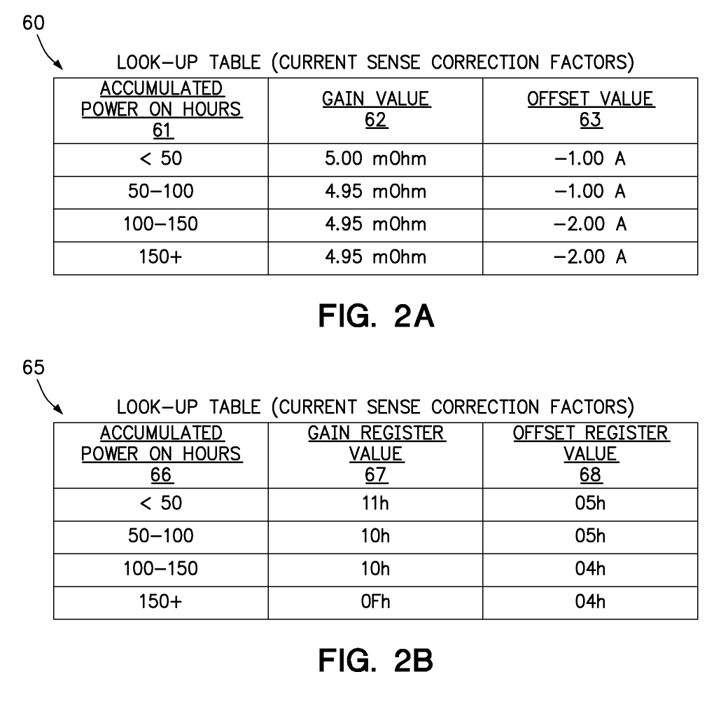

FIG. 2A is an illustration of a lookup table 60 that associates the present value of an operating parameter (column 61) of the voltage regulator with a gain value (column 62) and an offset value (column 63) that serve as current sense correction factors. The lookup table 60 may be stored in memory accessible to the BMC. While this lookup table uses a single accuracy degrading operating parameter (i.e., accumulated power on hours) associated with a pair of gain and offset values, a suitable lookup table may have any number of separate operating parameters that are used to determined which pair of gain and offset values should be used.

In the lookup table 60, the gain value is stated at a resistance (mOhm) and the offset value is stated as a current (Amps). Accordingly, the offset value (Amps) is summed with the apparent current (Amps), then the sum is multiplied by the gain (mOhm) to result in a voltage signal that is representative of the corrected current. It is not uncommon for current to be reported as a voltage that is proportional to the current. Alternatively, the gain could be a dimensionless value (i.e., no units of measure), such that the corrected current is represented as a current signal.

FIG. 2B is an illustration of another lookup table 65 that associates the present value of a voltage regulator operating parameter (column 66) with current sense correction factors (columns 67 and 68). However, in the lookup table 65, the correction factors are hexadecimal (h) values that are written to the registers associated with gain and offset in the voltage regulator. In either of FIGS. 2A and 2B, the offset value and/or the gain value may be selected dependent upon the present value of the operating parameter. The relationship between the value of the operating parameter and a given offset value, as well as the relationship between the value of the operating parameter and a given gain value, may be established based on empirical current sense accuracy drift data collection or modeling.

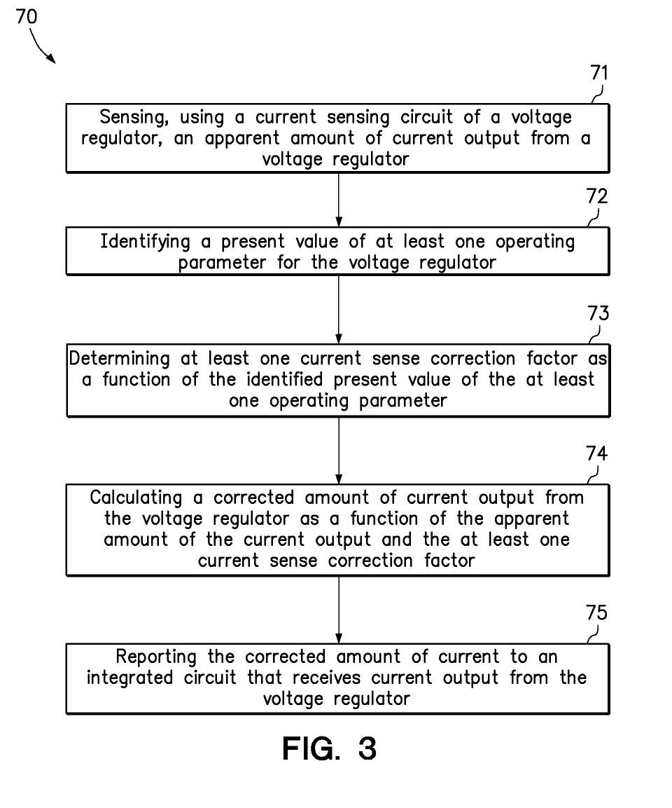

FIG. 3 is a flowchart of a method 70 according to one embodiment. Step 71 includes sensing, using a current sensing circuit of a voltage regulator, an apparent amount of current output from a voltage regulator. Step 72 includes identifying a present value of at least one operating parameter for the voltage regulator. Step 73 includes determining at least one current sense correction factor as a function of the identified present value of the at least one operating parameter. Step 74 includes calculating a corrected amount of current output from the voltage regulator as a function of the apparent amount of the current output and the at least one current sense correction factor. Still further, step 75 includes reporting the corrected amount of current to an integrated circuit that receives current output from the voltage regulator.

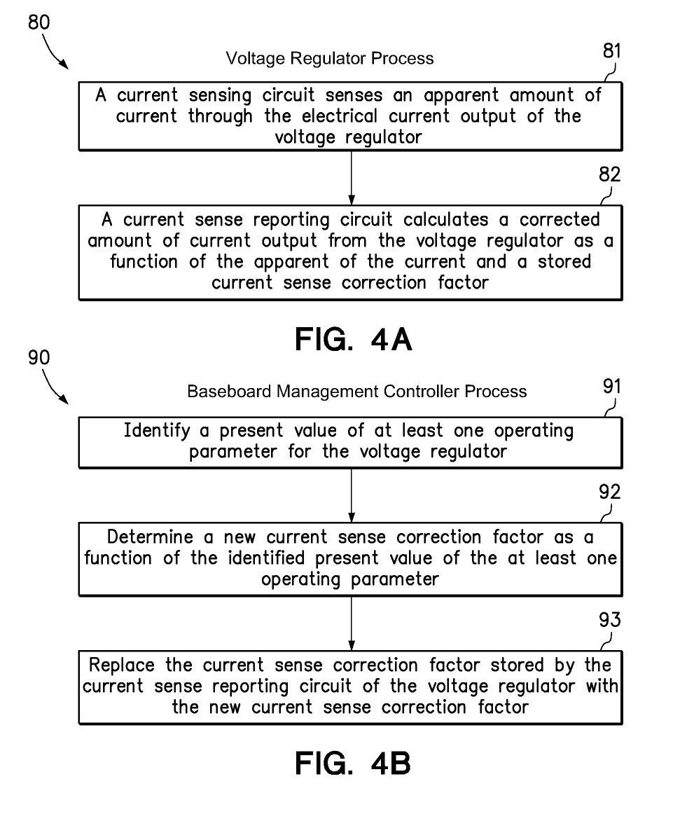

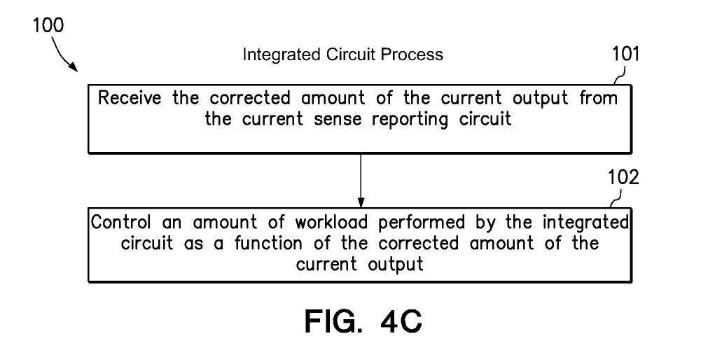

FIGS. 4A-4C are flowcharts for processes performed by the voltage regulator (FIG. 4A), baseboard management controller (FIG. 4B), and integrated circuit according to another embodiment (FIG. 4C).

FIG. 4A is a process 80 performed by a voltage regulator, such as the voltage regulator 20 of FIG. 1. In step 81, a current sensing circuit senses an apparent amount of current through the electrical current output of the voltage regulator. Then, in step 82, a current sense reporting circuit calculates a corrected amount of current output from the voltage regulator as a function of the apparent amount of the current and a stored current sense correction factor.

FIG. 4B is a process 90 performed by a baseboard management controller, such as the baseboard management controller 40 of FIG. 1. In step 91, the BMC will identify a present value of at least one operating parameter for the voltage regulator. Step 92 determines a new current sense correction factor as a function of the identified present value of the at least one operating parameter, and step 93 replaces the current sense correction factor stored by the current sense reporting circuit of the voltage regulator with the new current sense correction factor.

FIG. 4C is a process 100 that may be performed by an integrated circuit, such as the CPU 50 of FIG. 1. In step 101, the CPU receives the corrected amount of the current output from the current sense reporting circuit. In step 102, the CPU controls an amount of workload performed by the integrated circuit as a function of the corrected amount of the current output.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, an entire embodiment, or only certain aspects of an embodiment, may take the form of a computer program product embodied in one or more computer readable medium(s) having computer readable program code embodied thereon. For example, the baseboard management controller may process program instructions to perform various actions attributable to the baseboard management controller, while the current sense reporting circuit may be implemented entirely in hardware and/or firmware.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A method, comprising:
sensing, using a current sensing circuit of a voltage regulator, an apparent amount of current output from a voltage regulator;
identifying a present value of at least one operating parameter for the voltage regulator;
determining at least one current sense correction factor as a function of the identified present value of the at least one operating parameter;
calculating a corrected amount of current output from the voltage regulator as a function of the apparent amount of the current output and the at least one current sense correction factor; and
reporting the corrected amount of current to an integrated circuit that receives current output from the voltage regulator.

2. The method of claim 1, wherein the at least one operating parameter is selected from cumulative power-on time, cumulative time in operation above a temperature threshold, cumulative time in operation above a current threshold, present age of the voltage regulator, and combinations thereof.

3. The method of claim 1, wherein the at least one operating parameter includes an operating parameter that is cumulative over the lifetime of the voltage regulator.

4. The method of claim 1, further comprising:
dynamically updating the at least one current sense correction factor in response to changes in the present value of the operating parameter.

5. The method of claim 1, wherein the at least one current sense correction factor in each record has been predetermined to correct for an amount of current sensing accuracy drift measured in a nominally similar voltage regulator having similar values of the one or more operating parameter.

6. The method of claim 1, wherein the at least one current sense correction factor is selected from an offset value, a gain value, and combinations thereof.

7. The method of claim 1, wherein the at least one current sense correction factor includes an offset value and a gain value.

8. The method of claim 1, wherein the integrated circuit is a central processing unit.

9. The method of claim 1, wherein the at least one operating parameter includes a plurality of operating parameters.

10. The method of claim 1, wherein determining at least one current sense correction factor as a function of the identified present value of the at least one operating parameter, includes using a lookup table to find the at least one current sense correction factor that is associated with the identified present value of the at least one operating parameter.

11. The method of claim 10, wherein the lookup table includes multiple records based on actual current sense accuracy drift data collected during operation of another voltage regulator that is nominally similar to the voltage regulator, and wherein each record includes a value for the at least one operating parameter and a value for the at least one current sense correction factor.

12. The method of claim 11, wherein the at least one current sense correction factor includes an offset value and a gain value.

13. The method of claim 12, wherein the at least one operating parameter includes accumulated power-on time.

14. An apparatus, comprising:
a voltage regulator having an electrical current output, a current sensing circuit and a current sense reporting circuit, wherein the current sensing circuit senses an apparent amount of current through the electrical current output, and wherein the current sense reporting circuit stores a current sense correction factor and calculates a corrected amount of current output from the voltage regulator as a function of the apparent amount of the current and the stored current sense correction factor; and
a baseboard management controller in communication with the voltage regulator for identifying a present value of at least one operating parameter for the voltage regulator, determining a new current sense correction factor as a function of the identified present value of the at least one operating parameter, and replacing the current sense correction factor stored by the current sense reporting circuit with the new current sense correction factor; and
an integrated circuit in communication with the current sense reporting circuit for receiving the corrected amount of the current output and controlling an amount of workload performed by the integrated circuit as a function of the corrected amount of the current output.

15. The apparatus of claim 14, wherein the integrated circuit is a central processing unit, and wherein the central processing unit and the baseboard management controller are installed on the motherboard of a server.

16. The apparatus of claim 14, wherein each current sense correction factor is empirically predetermined to correct for an amount of current sensing accuracy drift measured by a current sensing circuit of a nominally similar voltage regulator having similar values of the at least one operating parameter.

17. The apparatus of claim 14, wherein the at least one operating parameter is selected from cumulative power-on time, cumulative time in operation above a temperature threshold, cumulative time in operation above a current threshold, present age of the voltage regulator, and combinations thereof.

18. The apparatus of claim 14, wherein the baseboard management controller determines the new current sense correction factor using a lookup table to find a current sense correction factor that is associated with the identified present value of the at least one operating parameter.

19. The apparatus of claim 14, wherein the at least one current sense correction factor is selected from an offset value, a gain value, and combinations thereof.

20. The apparatus of claim 14, wherein the at least one current sense correction factor includes an offset value and a gain value.
